(19) United States
(12) Patent Application Publication
(10) Pub. No.: US 2025/0342666 A1
(43) Pub. Date: Nov. 6, 2025

(54) Alignment of 3D Image Data Using Edges and Silhouettes

(71) Applicant: Novarad Corporation, Provo, UT (US)

(72) Inventors: Wendell Arlen Gibby, Mapleton, UT (US); Joel Steven Lyons, Springville, UT (US)

(21) Appl. No.: 19/197,913

(22) Filed: May 2, 2025

Related U.S. Application Data
(60) Provisional application No. 63/642,431, filed on May 3, 2024.

(51) Int. Cl. G06T 19/00; G06T 19/20

(52) U.S. Cl. CPC G06T 19/006; G06T 19/20; G06T 2200/24; G06T 2210/41; G06T 2219/2016

(57) ABSTRACT

Technology is described for aligning 3D image data with an anatomical structure of a person. The method can include displaying a slice of the 3D image data with respect to an axis. The slice may be locked to limit movement of the slice with respect to the axis. Adjustments to the slice with respect the axis may be received until an edge of the anatomical structure in the slice aligns with an edge of the anatomical structure of the person. The adjustments may allow the 3D image data to align with the person.

### PRIORITY CLAIM

This application claims priority to provisional patent application entitled ALIGNMENT OF 3D IMAGE DATA USING EDGES AND SILHOUETTES having Ser. No. 63/642,431 filed May 3, 2024.

### BACKGROUND

Mixed or augmented reality is an area of computing technology where views from the physical world and images from virtual computing worlds may be combined into a mixed reality world. In mixed reality, people, places, and objects from the physical world and virtual worlds become a blended visual and audio environment. A mixed reality experience may be provided through existing commercial or custom software along with the use of VR (virtual reality) or AR (augmented reality) headsets.

Augmented reality (AR) is an example of mixed reality where a live direct view (or an indirect view) of a physical, real-world environment is augmented or supplemented by computer-generated sensory input such as sound, video, graphics or other data. Augmentation may be performed as a real-world location is viewed and in context with environmental elements. With the help of advanced AR technology (e.g. adding computer vision and object recognition) the information about the surrounding real world of the user becomes interactive and may be digitally modified.

### BRIEF DESCRIPTION OF THE DRAWINGS

FIG. 1 is a diagram illustrating an example of 3D image data in a 3D coordinate space of an AR headset, which may be near to a person in a procedure.

FIG. 2 is an example of a slice selection that may be received from a user.

FIG. 3 illustrates an example of receiving adjustments to the 3D image data with respect to an identified axis.

FIG. 4 illustrates an example where alignment between the edge of the anatomical structure in the slice with an edge or a border of the anatomical structure of the person may be determined or confirmed by receiving input from a user (e.g., a medical professional) of the AR headset.

FIG. 5 illustrates that markers such as an optical tracker may be detected on the body of the person.

FIG. 6 illustrates that the user or doctor using the AR headset may view the optical codes from several angles to determine a more accurate location of the optical codes.

FIG. 7 illustrates the aligned 3D image data may then be associated with the optical code(s).

FIG. 8 is flowchart illustrating an example of a method for aligning 3D image data with an anatomical structure of a person.

FIG. 9 illustrates a computing device on which modules of this technology may execute.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

The ability to align 3D image data or a medical image with a person or patient using a head mounted display (e.g., an AR headset) can be valuable because the 3D image data (or image data set) can be used to guide a user or a medical professional (e.g., a doctor) during a medical procedure or to view highly detailed representations of the internal anatomy of the patient as visually overlaid on the patient prior to or during the medical procedure. Quickly and conveniently aligning the 3D image data to the person with a high level of accuracy can be challenging. Some previous alignment methods do not provide enough accuracy while other can be less convenient and complex to implement. For example, a medical professional may try to align 3D image data with a person by hand by dragging or adjusting the 3D image data to align with the person using the user interface of the AR headset. However, simply hand adjusting the 3D image data set can be quite difficult when there are three or six degrees of freedom for movement (i.e., 3 linear translation degrees of freedom and the 3 rotational axes degrees of freedom) for the 3D image data. Hand adjustments from one perspective can create problems for correct alignment from a different perspective of a head mounted display or AR headset.

In a further similar example, a medical professional may take 3D image data and generally move the 3D image data onto the patient. Then the medical professional may move the 3D image data set to align the 3D data set from the one perspective. At that point, the 3D image data may appear to be aligned from the first view through the AR headset where the medical professional is located. However, as soon at the medical professional moves to another angle with the AR headset, then the 3D data set may not appear to be aligned with the person or the anatomical structure from the additional angle. This may occur because determining alignment in the depth direction from any given perspective (the Z-axis from that single perspective) can be difficult for the user to determine through the AR headset. Then the user may try to align the 3D data set from a second perspective. However, when the user is aligning the 3D image data from the second view, determining the depth of the 3D image data in the second view can again be difficult for the user judge through the AR headset. In addition, the user may introduce errors into the alignment made from the first view point because it is difficult for the user to determine the depth at which the 3D image data is located from the second view point.

Another specific issue with receiving user input to hand align the 3D image data with an anatomical structure of a person is that the 3D image is a projected image in the AR headset and the brighter light from the projected image can obscure the anatomical structure of the person that the user wants to align with. For example, the user may see the 3D image data through the AR headset and use their hand move the 3D image data onto the body of the person. However, the bright 3D image data may obscure part or all of the anatomical structure of the person which may make alignment to the anatomical structure or body difficult when the area to be aligned with is covered or washed out by the brighter 3D image data.

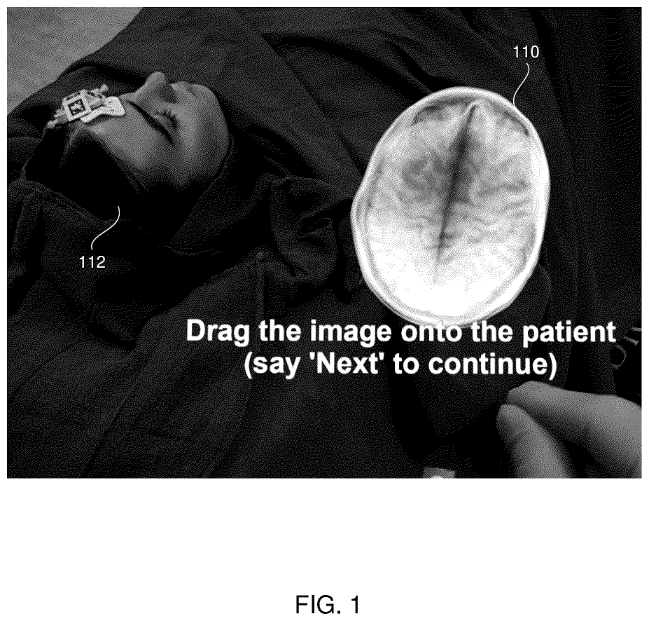

This technology may provide a method and system for aligning 3D image data with an anatomical structure of a person (e.g., a patient in a medical procedure). One process may include identifying the 3D image data that has a plurality of pre-defined axes or user selected axes, in proximity of the anatomical structure of the person. FIG. 1 illustrates that the 3D image data 110 may be in proximity to a person 112 that may be undergoing a procedure. Alternatively, the 3D image data 110 may be located anywhere in the 3D coordinate system of the AR headset. The 3D image data 110 may be dragged by the user (e.g., medical personnel) of the AR headset into the proximity of the person's anatomical structure. For example, the anatomical structure may be the person's head. This may be considered a starting point for the alignment process. If desired, the 3D image data may even be roughly or inaccurately placed on the anatomical structure of the person or patient.

A slice of the 3D image data orthogonal to an axis may be identified using the pre-defined axes or user selected axes. The slice selected may be along an axis that is selected from the pre-defined axes or other axes. For example, the pre-defined axes of the 3D image data set may be the sagittal, axial, and coronal axes of a person's anatomy in the 3D image data. Other medical axes of the person's body can also be used such as the transverse axis or plane, frontal axis (similar to axial) or plane, longitudinal axis, oblique axes, etc. depending on the desired axes or planes to be used and/or the anatomical structure being viewed. The axes used can be at any angle with respect to each other and do not necessarily need to be orthogonal to each other. The technology may present views of the anatomy in three different orthogonal axes.

In the examples of using the defined axes or defined axes of a person's body, the technology can enable a slice to be restricted in movement or locked on the selected axis and adjusted in the remaining orthogonal axes to the selected axis where the image is locked. Other axes that are not well known medical axes can be selected (e.g., a selected oblique axis) and these axes may be orthogonal to each other for use in the present technology. For example, the slice of the 3D image data may be sliced orthogonal to the selected axis and then the slice on the axis can be locked in the depth axis direction in the user's current perspective. A slice may be one or a few voxels wide from the 3D image data. The 3D image data and slice may be direct volume rendered and/or represent a 3D volume of anatomy scanned by a medical imaging device. In addition, the 3D image data may be a computed tomography (CT) scan or MRI (magnetic resonance imaging) image.

A slice of the 3D image data may be automatically identified that has a probability of matching the anatomical structure of the person viewed through the head mounted display or AR headset or detected from a position of the AR headset. The slice selected may be selected using AI or machine learning. Rule based implementations or pattern matching may also be used to select the slice. For example, a slice automatically selected may be anatomical structure in the image data set that has a widest diameter (widest diameter of the head, heart, torso or kidney) of the anatomical structure orthogonal to the axis of the 3D image data. In another example, a slice may be automatically selected that has a greatest total cross sectional area of the anatomical structure being selected (e.g., the nose on the head, the hand, the arm, the bone, etc.). In another example, a process may pick the slice with maximum extension from a cylindrical area of the anatomical structure (e.g., a nose from a head, a widest or fattest part of the body, etc.).

When selecting a slice, the user may want to select a slice where that anatomical structure being aligned is the widest or thickest because the 3D image data may be projected over the anatomical structure. The user may not be able to see anatomical structure that is covered by the projected 3D image data in the AR headset but having a wide slice may assist with better silhouette alignment.

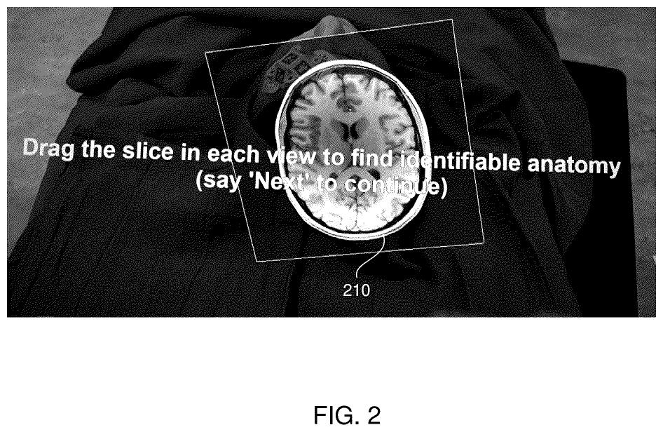

A slice selection may alternatively be received from a user 210, as illustrated in FIG. 2. The user may navigate (e.g., scroll, drag, activate user controls or buttons, etc.) through the slices that are in the 3D image data and then select a slice the user believes may match the desired anatomical structure with which the slice may be aligned. A user interface may be provided to enable navigation through a plurality of slice views from the 3D image data that are orthogonal to the axis presented to or selected by a user. A selection of a slice view by the user may be received through the user interface. For example, the user interface may be a hand gesture interface, a spoken interface or virtual objects representing virtual user interface controls.

As also mentioned, a user can use dragging navigation to drag through slices within the 3D image data set until a slice with the anatomical structure that is visible through the AR headset, (nose, eye balls, silhouette of anatomical structure) can be selected by the user. Dragging may show slices of the 3D image data sequentially in a spatial order (e.g., the user looks the slice closest to them followed by seeing the next farthest away slice) or the display of the slices may be out of order spatially (e.g., every third slice is shown, etc.) In one example, this may mean that from the side view of a person's head, the user can see the lips, chin and/or nose of the person in the slice of the 3D image data and also through the actual view of the AR headset (e.g., through the AR headset lenses). Further, the user may select a slice from the 3D image data set that has a profile or silhouette of the anatomical structure desired to be matched.

The movement of the slice may be limited with respect to the axis currently selected. For example, the slice may be restricted or locked to stop movement of the slice with respect to the axis. This means that the slice may not move or may only move a very limited amount in the direction of the axis (i.e., the depth axis).

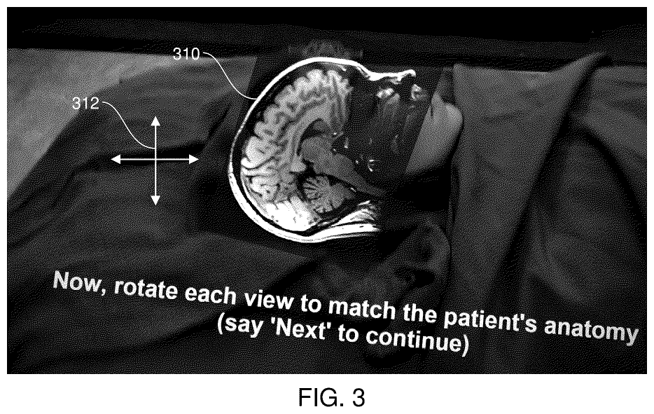

FIG. 3 illustrates that adjustments to a slice of the 3D image data that is orthogonal to the axis may be received. The adjustments may be substantially orthogonal 312 to the selected axis and little or no movement may be available in the selected axis direction (into the plane of FIG. 3). The adjustments to the slice may take place in a plane orthogonal to the depth axis (Z axis going into the page of the figure) and include translation and rotation adjustments for the slice in the plane. For example, this may allow the user to drag and rotate the slice of the 3D image data in one plane to line up more accurately on the edge or silhouette of the person's face (e.g., in the X and Y axis from the user of the AR headset's perspective). However, the user cannot really see whether there is correct alignment from the depth perspective because the 3D image data set may overlap the anatomy (e.g., the person's face) and it may be difficult to be able to judge depth of the slice based on just the size of the slice in the depth direction. Thus, the slice may be locked on the depth axis and the user does not have to work with a depth adjustment for that axis. The alignment in the depth axis can also be taken care of through adjustments viewed from another axis.

The adjustments may take place until an edge of the anatomical structure in the slice aligns with a border or edge of the anatomical structure of the person as detected from a perspective of an AR headset. The perspective of the AR headset may be on the selected axis or only a limited number of degrees off the selected axis (e.g., 1 to 35 degrees). This may allow the 3D image data to be aligned with the person. The adjustments to the slice can be applied to all the 3D image data. The edge in the slice may be a virtual edge from the 3D image data and the border or edge of the anatomical structure may a real edge as viewed by the user from being on axis with or nearly on axis with the selected axis from the AR headset.

In one example, the alignment between the edge of the anatomical structure in the slice with the edge or border of the anatomical structure of the person may be detected by using a sensor of the AR headset and an alignment process. For example, a computing process may automatically match the slice to the anatomical structure of the person using pattern matching or machine learning. The AR headset may capture the current view (e.g., real view) of the anatomical structure through a sensor of the AR headset (a camera, an infrared sensor or a time-of-flight (ToF) depth sensor). An example of a machine learning algorithm that might be used may be use of pattern matching. A further example of machine learning that might be used may be a recurrent neural network (RNN) or a convolutional neural network (CNN). The AR headset may present a notification to a user when the edge in the slice matches the border of the anatomical structure.

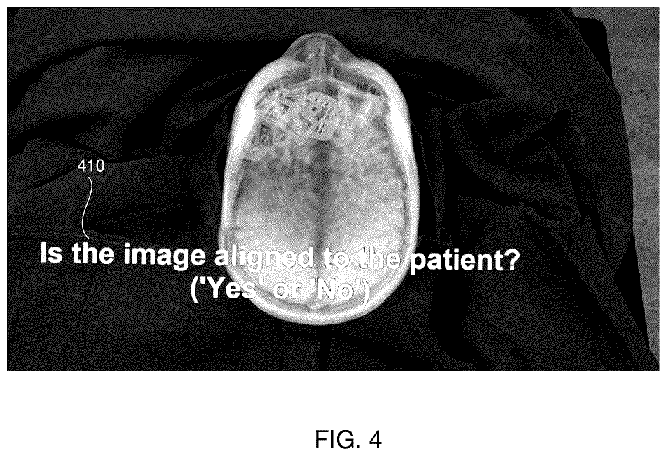

Alternatively, alignment between the edge of the anatomical structure in the slice with an edge or a border of the anatomical structure of the person may be determined by receiving input from a user 410 (e.g., a medical professional) of the AR headset, as illustrated in FIG. 4. For example, input regarding the alignment may be provided using a virtual button viewed through the AR headset, clicking of a remote handset, responding verbally to a verbal or written question or another user interface which may be activated by the user to indicate that the user believes alignment has occurred.

The operations of displaying a slice (e.g., including selecting or identifying a slice), limiting movement of the slice or locking the slice on an axis and receiving adjustments to the slice can be repeated in two additional axes. These changes may be applied to the image 3D image data set for each of the additional axes. When the operations have been performed in three axes then an accurate alignment may occur.

In a further example, a doctor can select and see a slice of the 3D image data set through the AR headset and the doctor can visually align the slice with an anatomical structure of the person or patient. The doctor can see the 3D image data set and may roughly place the 3D image data set on the anatomical structure of the person by dragging or using another user interface control to move the 3D image data. However, with a slice or 3D image data viewed through the AR headset, the brightness of the 3D image data set can obscure the anatomical structure of the person. Even if a slice of the image data set is used for alignment, it can be hard to align because aligning the depth of the slice is difficult. Generally, it is difficult to tell how much a slice, as viewed through an AR headset, is moved in the depth direction. It may be easy to under adjust or even over adjust when the slices are moved along a depth wise axis. Accordingly, the present technology may limit adjustments to the directions orthogonal the selected axis or depth-wise axis because the edge of the anatomical structure in the slice can be seen more easily than the depth of the slice.

Many types of 3D image data can be aligned to the body of the person or be aligned to the body of the person using a marker or other alignment systems. Medical imaging may be obtained and aligned with a body of a person. For example, a CT (computed tomography) scan, MRI (magnetic resonance imaging) image or other imaging may be overlaid on the patient and used as a reference for aspects of a patient's anatomical structure being operated on. U.S. Pat. Nos. 9,892,564; 10,475,244; 11,004,271; 10,010,379; 10,945,807; 11,266,480; 10,825,563; 11,237,627; 11,287,874; U.S. patent application Ser. No.: 17/706,462 entitled “Using Optical Codes with Augmented Reality Displays”; and U.S. patent application Ser. No.: 17/536,009 entitled “Image Data Set Alignment for an AR Headset Using Anatomic Structures and Data Fitting”; and U.S. patent application Ser. No.: 17/978,962 entitled “3D Spatial Mapping in a 3D Coordinate System of an AR Headset Using 2D Images” describe related information for methods and systems for aligning an image data set from medical imaging devices with a body of a person and these descriptions are incorporated in their entirety by reference herein to further explain aspects of the technology. These incorporated patents and patent applications also describe a wide variety of medical imaging types that may be used to obtain 3D image data sets.

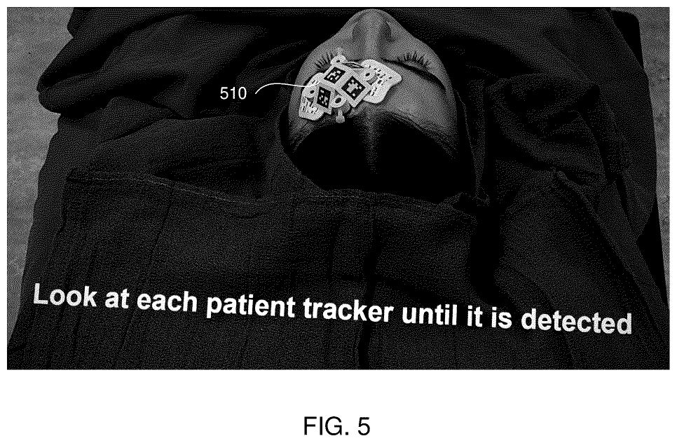

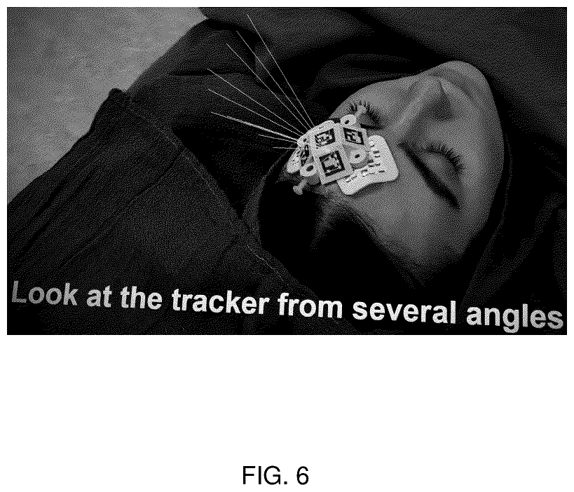

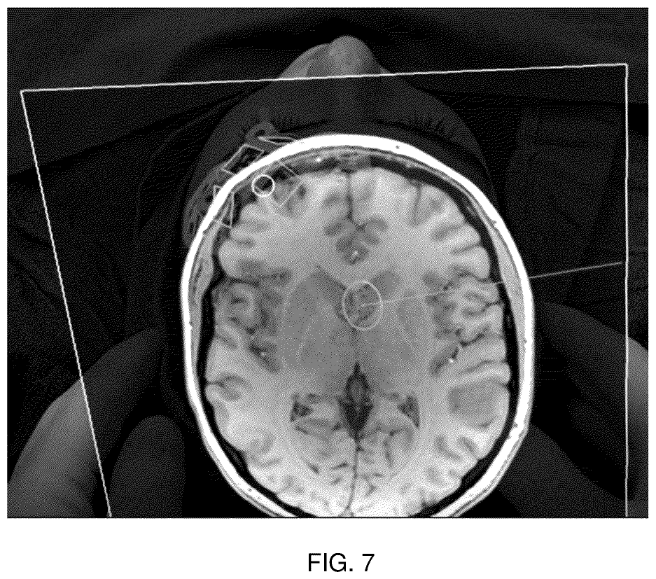

FIG. 5 illustrates that markers such as an optical tracker may be detected on the body of the person. In this case, optical codes 520 are used as the markers and may be attached to the body of the person. FIG. 6 illustrates that the user or doctor using the AR headset may view the optical codes from several angles in order to determine a more accurate location of the optical codes with an image visible marker under the optical codes (i.e., not seen in FIG. 6) in the 3D coordinate space of the AR headset. FIG. 7 illustrates that the aligned 3D image data may then be associated with or linked to the movement of the optical code(s). Then as person's body (e.g., head moves), the movement of the optical codes may be used to move the 3D image data with the movement of the body of the person (e.g., head). For example, if the person's body (e.g., head) move 3 millimeters to the left, then the 3D image data may be moved 3 millimeters to the left.

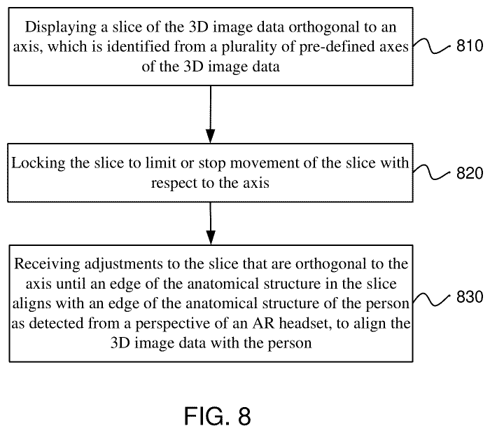

FIG. 8 illustrates a flow chart of a method for aligning 3D image data with an anatomical structure of a person using a head mounted display (e.g., an AR headset). The 3D image data may be displayed at a location in the 3D coordinate system viewable by the AR headset or a head mounted display. The location of the 3D image data in the 3D coordinate system of the AR headset may be determined automatically to be a defined distance from a detected person or just a pre-defined location in the 3D coordinate space of the AR headset. The AR headset or the user may roughly place the 3D image data near the anatomical structure of the person (e.g., in the medical procedure). Further, the 3D image data may be near to the anatomical structure of the person as automatically placed when the 3D image data is loaded into the AR headset. In another example, the 3D image data may be moved by a user (e.g., dragging or navigating) to a position where the anatomical structure can be viewed at the same time as 3D image data set through the AR headset. If desired, the user can roughly align the 3D image data set with the anatomical structure of the person or patient before proceeding to perform more accurate alignment.

One operation in the method may be displaying a slice of the 3D image data, as in block 810. The slice of image data may be displayed orthogonal to an axis. The axis maybe identified from a plurality of pre-defined axes of the 3D image data. For example, the pre-defined axes may be the sagittal, axial, and coronal axes or other custom orthogonal axes may be selected. The axis selected to be used may be an axis nearest to the AR headset. Alternatively, a user may provide input on which axis is to be selected. The axis selected may use a well-known medical axis or plane of the person or an axis orthogonal to the anatomical structure which with the slice is to be aligned. In an alternative example, oblique axes that are orthogonal to each other may be used.

The slice may be selected by a computing process where a slice matching a specific criterion may be selected. Criteria for selecting a slice may be the width of anatomy in the slice or how similar an edge found in the slice is to a particular anatomical structure or pattern (e.g., of a normal nose). For example, cach slice could be checked for the desired edge or border from the anatomical structure. The slice may also be selected by a user dragging or scrolling through the slices of the 3D image data.

Another operation may be limiting movement of the slice to limit or stop movement of the slice with respect to the currently selected axis, as in block 820. This may be described as locking a slice of the 3D image data for at least one of the three orthogonal planes. More specifically, the selected slice of the 3D image data set can be locked or fixed at a current or defined depth with respect to the selected axis.

As discussed, the axis on which the slice has limited movement or is locked may be the axis that is nearest to the AR headset. If a user walks around a person or patient to look at the side of the person's head, the user's head may not be perfectly perpendicular to the person's head and the user may have an oblique view of the person. However, the AR headset can select or present slices that are orthogonal to the three axes chosen. Then the degrees of freedom for that slice are reduced so the slice can be adjusted in the X, Y plane from the user's perspective but not in the depth direction (or at least a limited amount in the depth direction). The user's perspective using the AR headset may be on axis or nearly on axis to the selected axis. The process on AR headset can limit or lock the slice (e.g., slice of the virtual image) into a single plane. Then the user can adjust the slice in the one plane, and then adjust a different orthogonal slice in a second plane and a third orthogonal slice in a third plane. This can provide an accurate alignment or co-registration in three dimensions.

As a result, adjustments to the slice may be received that are orthogonal to the axis until an edge of the anatomical structure in the slice aligns with an edge of the anatomical structure of the person, as in block 830. The alignment may occur by matching the edge of the slice from the 3D image data to the contour of the real anatomy viewed through the AR headset from that perspective.

For example, the process or a user may move (e.g., automatically move or drag) the slice until an edge in the slice or a silhouette identified in the slice matches an edge or border of the anatomical structure of the person. This process allows the user to quickly and accurately register the 3D image data to the anatomical structure of a person (e.g., a patient in a medical procedure). These alignments may be determined as detected from a perspective of an AR headset in order to align the 3D image data with the person. The adjustments to the slice can be further applied to the entire set of 3D image data.

The edge or border of the anatomical structure may also appear to be a silhouette of the anatomical structure, such as the silhouette of a person's head, face, arms, legs, hands, torso, etc. The silhouette may be a full 360 degree silhouette or a partial silhouette of an anatomical structure.

An alignment between the edge of the anatomical structure in the slice and an edge of the anatomical structure of the person can be detected by using a sensor of the AR headset and an edge detection process or artificial intelligence. In another embodiment, an alignment between the edge of the anatomical structure in the slice and an edge of the anatomical structure of the person can be detected by using an image from a visible light camera of the AR headset and an edge detection process or artificial intelligence. An image may also be captured and used that is an infrared image, LIDAR (Light Detection and Ranging) image, a depth image, or another imaging modality that is a sensor on the AR headset. Alternatively, the alignment may be flagged using feedback from a user.

The operations of displaying a slice, locking the slice and receiving adjustments to the 3D image data may be performed for two additional axes. Each time an axis is selected automatically or picked by a user, the slice that has been selected can be limited in the axis or locked onto the selected one of the 3 orthogonal axes. The operations, including locking, may occur for each of the 3 orthogonal axes. In an example, the user may start with the sagittal plane and then the user may change to the axial view. When the user changes view, the user may see the slice needs to be rotated and shifted some to further align the nose in that view. The alignment that is confined to one plane can be done for each of the 3 orthogonal axes. This may provide a comparatively fast and quite accurate alignment of the 3D data set using the contour of the anatomy or a silhouette of the anatomy on the 3 axes.

Accordingly, this technology may provide the ability to align the 3D data set with the body of the person even though such alignment may hard where there are 3 degrees of freedom or 6 degrees of freedom to align the 3D data image with the body of the person. This alignment may take place using the edges, borders or silhouettes of anatomy in the 3D data set and in the actual view or direct view of the person through the AR headset. The user may look at the silhouette view of the anatomical structure in a slice of the 3D image data and align that with the silhouette of the anatomical structure the user can see through the AR headset. Using the boundary or edge of the anatomical structure can help to align the slice with the anatomical structure in one axis and this may be repeated for at least two additional axes. The alignment of the slices is applied to the entire 3D image data.

In many existing alignment processes, the user cannot see the 3D data set or the virtual object that is being aligned before it actually aligned. This is because markers, optical codes, radiopaque markers or similar alignment schemes may be used and the alignment occurs automatically using the defined alignment process. This technology allows the user to see the alignment as the alignment is taking place with the person's body or patient's body. In addition, the user can be involved in the alignment process for each axis if desired. For example, if an automatic alignment is made for an axis by the process on the AR headset but the user feels like a better adjustment could be made, then the user can adjust what the process has done to improve the alignment. Alternatively, the user can input the adjustments to a locked slice on their own.

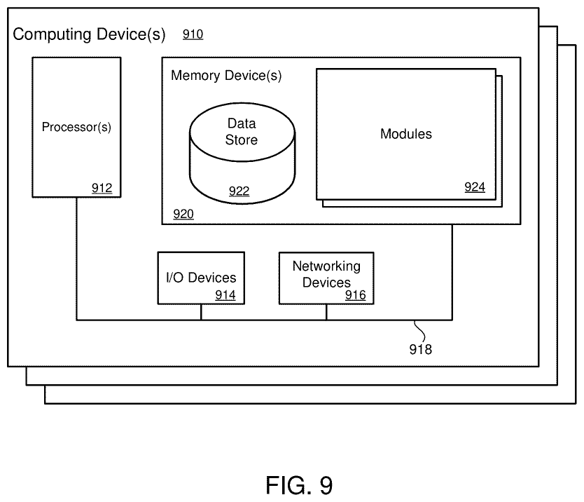

FIG. 9 illustrates a computing device 910 on which modules of this technology may execute. The computing device 910 is illustrated on which a high level example of the technology may be executed. The computing device 910 may include one or more processors 912 that are in communication with memory devices 920. The computing device may include a local communication interface 918 for the components in the computing device. For example, the local communication interface may be a local data bus and/or any related address or control busses as may be desired.

The memory device 920 may contain modules 924 that are executable by the processor(s) 912 and data for the modules 924. The modules 924 may execute the functions described earlier. A data store 922 may also be located in the memory device 920 for storing data related to the modules 924 and other applications along with an operating system that is executable by the processor(s) 912.

Other applications may also be stored in the memory device 920 and may be executable by the processor(s) 912. Components or modules discussed in this description that may be implemented in the form of software using high programming level languages that are compiled, interpreted or executed using a hybrid of the methods.

The computing device may also have access to I/O (input/output) devices 914 that are usable by the computing devices. An example of an I/O device is a display screen that is available to display output from the computing devices. Other known I/O device may be used with the computing device as desired. Networking devices 916 and similar communication devices may be included in the computing device. The networking devices 916 may be wired or wireless networking devices that connect to the internet, a LAN, WAN, or other computing network.

The components or modules that are shown as being stored in the memory device 920 may be executed by the processor 912. The term “executable” may mean a program file that is in a form that may be executed by a processor 912. For example, a program in a higher level language may be compiled into machine code in a format that may be loaded into a random access portion of the memory device 920 and executed by the processor 912, or source code may be loaded by another executable program and interpreted to generate instructions in a random access portion of the memory to be executed by a processor. The executable program may be stored in any portion or component of the memory device 920. For example, the memory device 920 may be random access memory (RAM), read only memory (ROM), flash memory, a solid state drive, memory card, a hard drive, optical disk, floppy disk, magnetic tape, or any other memory components.

The processor 912 may represent multiple processors and the memory 920 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification may have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for aligning 3D image data with an anatomical structure of a person using a head mounted display, comprising:
displaying a slice of the 3D image data with respect to an axis; and
receiving adjustments to the slice until an edge of the anatomical structure in the slice aligns with an edge of the anatomical structure of the person.

2. The method as in claim 1, further comprising limiting movement of the slice with respect to the axis.

3. The method as in claim 1, further comprising displaying the slice of the 3D image data orthogonal to the axis.

4. The method as in claim 1, wherein the axis is identified from a plurality of pre-defined axes of the 3D image data.

5. The method as in claim 1, further comprising receiving adjustments to the slice that are orthogonal to the axis, until the edge of the anatomical structure in the slice aligns with the edge of the anatomical structure of the person, as detected from a perspective of an AR headset.

6. The method as in claim 1, further comprising applying the adjustments to the slice to the 3D image data.

7. The method as in claim 3, further comprising repeating the displaying the slice, limiting movement of the slice and receiving adjustments to the 3D image data for two additional axes.

8. The method as in claim 1, wherein an alignment between the edge of the anatomical structure in the slice and the edge of the anatomical structure of the person is detected by using a sensor of a head mounted display and an edge detection process.

9. The method as in claim 4, wherein the axis may be selected from at least one of: sagittal, axial, and coronal axes of a person's anatomy in the 3D image data.

10. A method for aligning 3D image data with an anatomical structure of a person, comprising:
identifying the 3D image data, having a plurality of pre-defined axes, in proximity of the anatomical structure of the person;
displaying a slice of the 3D image data orthogonal to an axis identified from the pre-defined axes;
locking the slice to stop movement of the slice with respect to the axis;
receiving adjustments to the slice of the 3D image data that are orthogonal to the axis until an edge of the anatomical structure in the slice aligns with an edge of the anatomical structure of the person as detected from a perspective of an AR headset, in order to align the 3D image data with the person; and
applying the adjustments to the 3D image data.

11. The method as in claim 10, further comprising repeating the displaying the slice, locking the slice and receiving adjustments to the 3D image data in two additional axes.

12. The method as in claim 10, wherein alignment between the edge of the anatomical structure in the slice aligns with the edge of the anatomical structure of the person is detected by using a sensor of the AR headset and an alignment process.

13. The method as in claim 10, wherein alignment between the edge of the anatomical structure in the slice with a border of the anatomical structure of the person is determined by receiving input from a user of the AR headset.

14. The method as in claim 10, wherein the adjustments to the slice take place in a plane and include translation and rotation adjustments in the plane.

15. The method as in claim 10, further comprising identifying the slice of the 3D image data that has a probability of matching the anatomical structure of the person.

16. The method as in claim 10, further comprising matching the slice of the 3D image data to anatomical structure of the person using pattern matching or machine learning.

17. The method as in claim 10, further comprising sending a notification when the slice of the 3D image data matches the edge of the anatomical structure of the person.

18. The method as in claim 10, further comprising identifying the slice of the 3D image data that includes anatomical structure with a widest diameter of the anatomical structure orthogonal to the axis.

19. The method as in claim 10, further comprising receiving a slice selection from a user.

20. The method as in claim 19, further comprising:
enabling navigation through a plurality of slice views that are orthogonal to the axis by the user; and
receiving a selection of a slice view by the user.

21. The method as in claim 10, further comprising aligning the 3D image data to the anatomical structure using a silhouette of the anatomical structure of the person in the slice as aligned to a silhouette of the anatomical structure detectable by the AR headset.

22. A system for aligning a 3D image data with an anatomical structure of a person, the system comprising:
at least one processor;
at least one memory device including a data store to store a plurality of data and instructions that, when executed, cause the system to:
identify the 3D image data in proximity of the anatomical structure of the person,
wherein the 3D image data has a plurality of pre-defined axes;
displaying a slice of the 3D image data orthogonal to an axis identified from the pre-defined axes;
locking the slice to stop movement of the slice with respect to the axis;
receiving adjustments to the 3D image data that are orthogonal to the axis until an edge of the anatomical structure in the slice aligns with a border of the anatomical structure of the person as detected from a perspective of an AR headset, in order to align the 3D image data with the person for the perspective; and
applying the adjustments to the 3D image data.

23. The system as in claim 22, further comprising repeating the displaying the slice, locking the slice and receiving adjustments to the 3D image data in two additional axes.

24. The system as in claim 22, wherein alignment between the edge of the anatomical structure in the slice aligns with the edge of the anatomical structure of the person is detected by using a sensor of the AR headset and an alignment process.
